(19) United States
(12) Patent Application Publication
(10) Pub. No.: US 2013/0314809 A1
(43) Pub. Date: Nov. 28, 2013

(54) LENS DRIVE DEVICE AND IMAGING DEVICE

(71) Applicants: Hiroyuki Watanabe, Shiroi-shi (JP); Yohsuke Ikeda, Soka-shi (JP); Takafumi Ishikawa, Saitama-shi (JP); Takuma Ishikawa, Itabashi-ku (JP); Hiroki Ito, Itabashi-ku (JP)

(72) Inventors: Hiroyuki Watanabe, Shiroi-shi (JP); Yohsuke Ikeda, Soka-shi (JP); Takafumi Ishikawa, Saitama-shi (JP); Takuma Ishikawa, Itabashi-ku (JP); Hiroki Ito, Itabashi-ku (JP)

(21) Appl. No.: 13/981,481

(22) PCT Filed: Jan. 30, 2012
(86) PCT No.: PCT/JP2012/051996

§ 371 Date: Jul. 24, 2013

(30) Foreign Application Priority Data
Jan. 31, 2011 (JP) 2011-018593
Nov. 4, 2011 (JP) 2011-242666

(51) Int. Cl. G02B 7/04

(52) U.S. Cl. CPC G02B 7/04
USPC 359/823

(57) ABSTRACT

The present invention provides a lens drive device including a base member arranged inside a lens barrel, a lens frame holding a lens and provided to be movable with respect to the base member in an optical axis direction of the lens, a voice coil motor for moving the lens frame, and a position detection unit for detecting a position of the lens frame. The position detection unit includes a reflection portion provided to one of the base and the lens frame and including a reflection surface inclined with respect to the optical axis of the lens, and a photoreflector provided to the other of the base member and the lens frame and including a light projecting portion applying light to the reflection surface and a light receiving portion receiving light reflected on a reflection flat surface.

### TECHNICAL FIELD

The present invention relates to a lens drive device that drives a lens in an optical axis direction, and an imaging device including the lens drive device.

### BACKGROUND ART

Japanese Patent Application Laid-Open Publication No. 2008-83396 is a technical literature in such a field. This publication describes a lens position detection mechanism including a photoreflector having a light projecting portion applying light and a light receiving portion receiving light, and a lens holder having a side surface portion opposed to the photoreflector and moving relative to the photoreflector. A through hole is formed in the side surface portion of the lens holder, and an interior reflector plate is exposed from the through hole. The position detection mechanism configured in this manner can detect the position of the lens holder based on the difference in amount of receiving light between when the photoreflector is opposed to the reflector plate and when it is not opposed.

### CITATION LIST

### Patent Literature

[Patent Literature 1] Japanese Patent Application Laid-Open Publication No. 2008-83396

### SUMMARY OF INVENTION

### Technical Problem

The conventional position detection mechanism described above, however, can detect the position of the lens only in two stages, namely, when the photoreflector is opposed to the reflector plate in the through hole and when it is not opposed, resulting in a low resolution which makes fine lens position detection impossible.

The present invention therefore aims to provide a lens drive device capable of lens position detection with high accuracy and high resolution.

### Solution to Problem

In order to solve the above-mentioned problem, the present invention provides a lens drive device which includes a base arranged inside a barrel, a lens frame holding a lens and provided to be movable with respect to the base in an optical axis direction of the lens, driving means for moving the lens frame, and position detection means for detecting a position of the lens frame. The position detection means includes a reflection portion provided to one of the base and the lens frame and including a reflection surface inclined with respect to the optical axis of the lens, and a photoreflector provided to the other of the base and the lens frame and including a light projecting portion applying light to the reflection surface and a light receiving portion receiving light reflected on the reflection surface.

In the lens drive device according to the present invention, the distance between the reflection surface of the reflection portion and the photoreflector changes in accordance with the position of the lens frame, so that the position of the lens frame can be detected by detecting this distance with the photoreflector. Since the reflection surface is inclined with respect to the optical axis, the distance between the reflection surface and the photoreflector continuously changes in accordance with the position of the lens frame. Since the reflection surface is a flat surface having constant inclination, the position of the lens frame can be specified based on the distance between the reflection surface and the photoreflector. Accordingly, this lens drive device can detect the distance from the reflection surface using the photoreflector thereby precisely specifying the position of the lens frame corresponding to the detected distance. Accordingly, lens position detection can be performed with high accuracy and high resolution.

In the lens drive device according to the present invention, it is preferable that the reflection surface of the reflection portion and a light projecting/receiving surface of the photoreflector face each other.

In the lens drive device according to the present invention, the reflection surface and the light projecting/receiving surface face each other, so that light can be reliably projected and received by the photoreflector, compared with a case where they do not face each other. The detection accuracy of the photoreflector is thus improved.

In the lens drive device according to the present invention, it is preferable that the base be a plate-shaped member, the reflection portion be an upright piece provided upright on the base along the optical axis direction, and the photoreflector be provided to the lens frame.

In the lens drive device according to the present invention compared with a case where the reflection portion is provided to the lens frame, it is not necessary to arrange the photoreflector at a distance from the base in order to accommodate the moving range of the lens frame. This can simplify the structure and is advantageous in size reduction of the device.

In the lens drive device according to the present invention, it is preferable that, in an output voltage characteristic of the photoreflector with respect to the distance between the photoreflector and the reflection surface, a range in which a rate of change of the output voltage with respect to the distance is high be set as a lens position detection area for either a lens position detection area for focus or a lens position detection area for camera stop, and another range in which the rate of change is smaller than in the range be set as the other lens position detection area.

In the lens drive device according to the present invention, compared with a conventional device in which a range in which the rate of change of the output voltage with respect to the distance between the photoreflector and the reflection surface is high is used for lens position detection, the available range of the output voltage characteristic can be enlarged, thereby enlarging a range in which lens position can be detected. The use of a wide output voltage characteristic can improve the accuracy of lens position detection.

In the lens drive device according to the present invention, it is preferable that, in a lens position detection area for focus in the output voltage characteristic of the photoreflector with respect to a distance between the photoreflector and the reflection surface, a range in which a rate of change of the output voltage with respect to the distance is high be set as a lens position detection area for either a lens position detection area for short distance or a lens position detection area for long distance, and another range in which the rate of change is smaller than in the range be set as the other lens position detection area.

In the lens drive device according to the present invention, the lens position detection area for short distance and the lens position detection area for long distance are set in accordance with the magnitude of the rate of change of the output voltage with respect to the detected distance in the lens position detection area for focus, thereby implementing lens position detection suited for respective imaging conditions for short distance and for long distance.

It is preferable that the lens drive device according to the present invention further include a guide shaft that includes a base end fixed to the base, extends in the optical axis direction, and includes a stopper for restricting a moving range of the lens frame provided to a tip end of the guide shaft.

In the lens drive device according to the present invention, the guide shaft allows the lens frame to be guided in the optical axis direction, thereby allowing the lens frame to be moved accurately. The provision of the stopper at the guide shaft can reduce the number of components and simplify the structure compared with providing an additional member as a stopper.

It is preferable that the lens drive device according to the present invention further include a tubular guide member that has a guide groove extending in the optical axis direction and is fixed to the base while surrounding the lens frame. It is preferable that the lens frame include a projection portion that is engaged with the guide groove and is slidable along the guide groove.

In the lens drive device according to the present invention, the projection portion engaged with the guide groove of the guide member slides along the guide groove in accordance with the movement of the lens frame, thereby allowing the lens frame to be moved accurately in the optical axis direction.

In the lens drive device according to the present invention, it is preferable that the base have a visual recognition hole for visually recognizing the lens frame.

In the lens drive device according to the present invention, the visual recognition hole in the base is used to facilitate position adjustment of the lens frame even after the lens drive device is mounted on the imaging device, thereby improving the efficiency of assembly operation.

In the lens drive device according to the present invention, it is preferable that the reflection surface be a flat surface or a curved surface capable of collecting light.

Forming the reflection surface in a curved surface capable of collecting light enables sensing light efficiently with a small quantity of light and improving the accuracy of position detection even with a small reflection portion.

In the lens drive device according to the present invention, it is preferable that the reflection surface be formed in a sawtooth shape in a cross section.

By employing such a configuration, the inclination angle of the reflection surface can be increased. This can increase a change in the amount of receiving light and can improve the accuracy of position detection even if the reflection portion is small.

An imaging device according to the present invention includes the lens drive device as described above.

The imaging device according to the present invention can perform lens position detection with high accuracy and high resolution, thereby improving the imaging performance.

### Advantageous Effects of Invention

The present invention enables lens position detection with high accuracy and high resolution.

### BRIEF DESCRIPTION OF DRAWINGS

FIG. 1 is an exploded perspective view showing a lens drive device according to a first embodiment.

FIG. 2 is a perspective view showing the lens drive device in FIG. 1.

FIG. 3 is a plan view showing the lens drive device in FIG. 1.

FIG. 4 is a perspective view showing a lens frame in FIG. 1.

FIG. 5 is a perspective view showing a base member in FIG. 1.

FIG. 6 is a perspective view of the lens drive device showing a state in which the lens frame is at a camera stop position.

FIG. 7 is a sectional view along a line VII-VII in FIG. 6.

FIG. 8 is a sectional view along a line VIII-VIII in FIG. 6.

FIG. 9 is a perspective view of the lens drive device showing a state in which the lens frame is at a stopper position.

FIG. 10 is a sectional view along a line X-X in FIG. 9.

FIG. 11 is a sectional view along a line XI-XI in FIG. 9.

FIG. 12 is a graph for explaining a focus area of an output voltage characteristic of a photoreflector.

FIG. 13 is a graph for explaining a fine movement area and a coarse movement area of the output voltage characteristic of the photoreflector.

FIG. 14 is a graph for explaining another example of the fine movement area and the coarse movement area of the output voltage characteristic of the photoreflector.

FIG. 15 is a graph for explaining yet another example of the fine movement area and the coarse movement area of the output voltage characteristic of the photoreflector.

FIG. 16 is a perspective view showing a lens drive device according to a second embodiment.

FIG. 17 is a sectional view along a line XVII-XVII in FIG. 16.

FIG. 18 is an exploded perspective view showing a lens drive device according to a third embodiment.

FIG. 19 is a perspective view showing the lens drive device in FIG. 18.

FIG. 20 is a perspective view showing a lens frame in FIG. 18.

FIG. 21 is a perspective view showing another modification of a reflection surface.

FIG. 22 is a perspective view showing a further modification of the reflection surface.

FIG. 23 is a perspective view showing yet another modification of the reflection surface.

### DESCRIPTION OF EMBODIMENTS

Preferred embodiments of the present invention will be described below in detail with reference to the drawings. In the drawings, the same or corresponding parts are denoted with the same reference signs and an overlapping description is omitted. The size, shape, and magnitude relation between components in the drawings are not always the same as the actual ones.

### First Embodiment

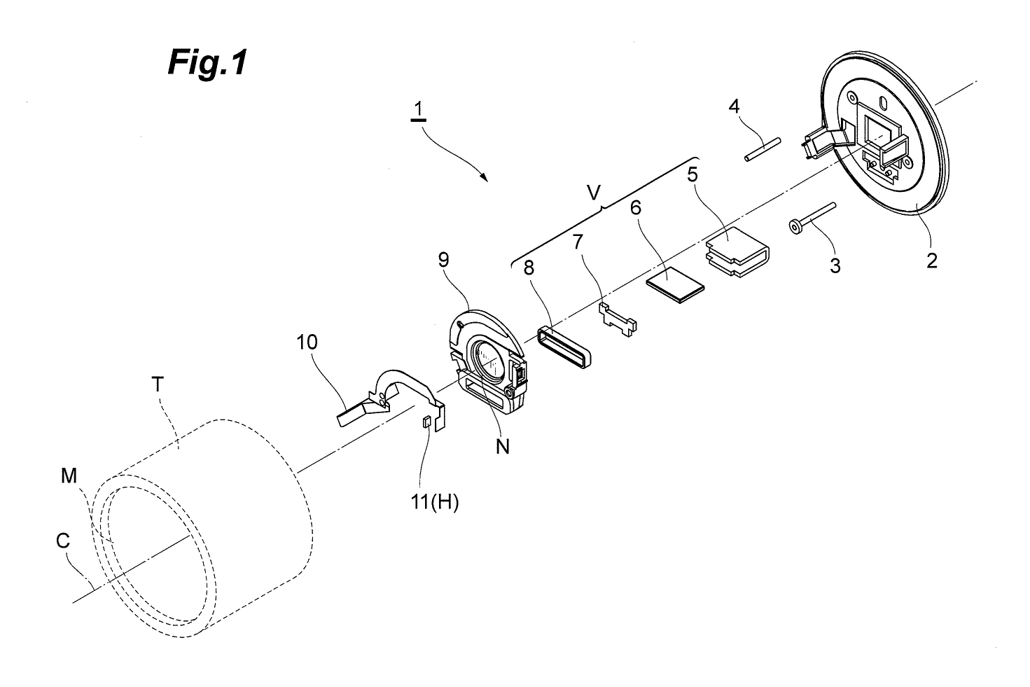

As shown in FIG. 1 to FIG. 3, a lens drive device 1 according to a first embodiment is built in a retractable camera having a lens barrel T capable of being stored in a camera body and drives a focus lens N. The lens drive device 1 is arranged inside the lens barrel T. The focus lens N is arranged such that the optical axis C of the focus lens N coincides with the optical axis of a master lens M in the lens barrel T. The focus lens N is a lens group formed with a plurality of lenses. The lens drive device 1 drives the focus lens N in a direction along the optical axis C (hereinafter referred to as “optical axis direction C”).

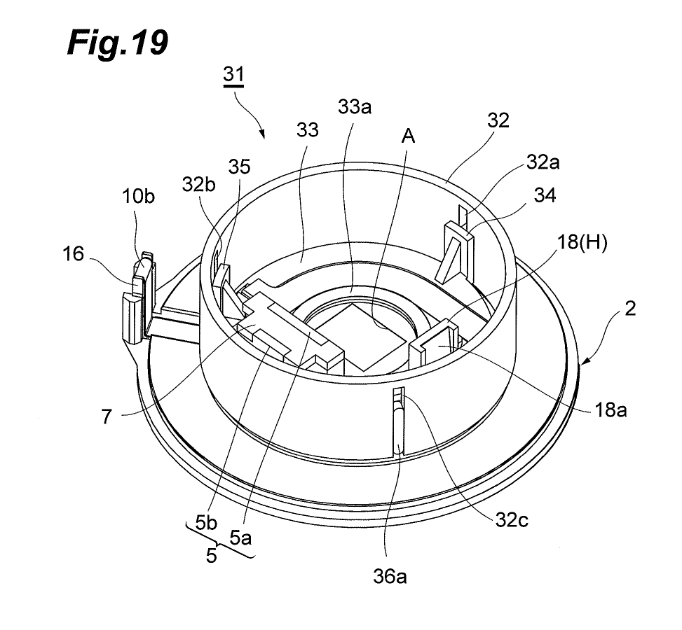

An imaging element (not shown) such as a CCD (charge-coupled device) image sensor and a CMOS (complementary metal oxide semiconductor) image sensor is arranged behind the lens drive device 1. It is noted that the lens N is not shown in the drawings except FIGS. 1, 4, 17, and 19 for the sake of easy understanding.

The lens drive device 1 includes a base member 2, guide shafts 3 and 4, a first yoke 5, a magnet 6, a second yoke 7, a coil 8, a lens frame 9, an FPC (flexible printed circuit) 10, and a photoreflector 11.

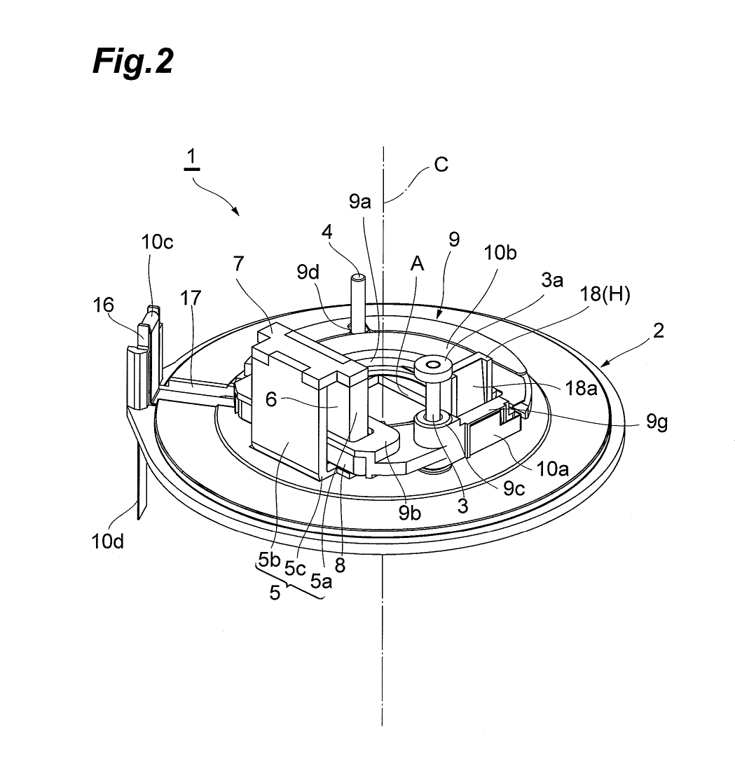

As shown in FIG. 2 to FIG. 5, the base member 2 is a disk-shaped member having an opening A at the center thereof. The lens frame 9 holding the lens N is arranged on the base member 2. The lens frame 9 is an annular member having a lens hole 9a at the center thereof in which the lens N is fitted. The lens N held by the lens frame 9 is positioned above the opening A of the base member 2. The guide shafts 3 and 4 for guiding the movement of the lens frame 9 are inserted through shaft insertion holes 9c and 9d, respectively, of the lens frame 9.

The guide shafts 3 and 4 are members extending in the optical axis direction C. The guide shafts 3 and 4 are provided upright on the base member 2. The guide shafts 3 and 4 are fitted in shaft holes 13 and 14, respectively, of the base member 2. The shaft holes 13 and 14 are formed to sandwich the opening A. An annular stopper 3a for restricting the moving range of the lens frame 9 is provided at the tip end of the guide shaft 3.

The provision of such guide shafts 3 and 4 enables the lens frame 9 to be guided in the optical axis direction C and enables the lens frame 9 to move accurately. The provision of the stopper 3a to the guide shaft 3, 4 can reduce the number of components and simplify the structure compared with providing an additional member as a stopper.

As shown in FIG. 1 to FIG. 3, the first yoke 5, the magnet 6, the second yoke 7, and the coil 8 constitute a voice coil motor (drive means) V for driving the lens frame 9. In the voice coil motor V, the magnet 6 is attached to the base member 2 and the coil 8 is attached to the lens frame 9.

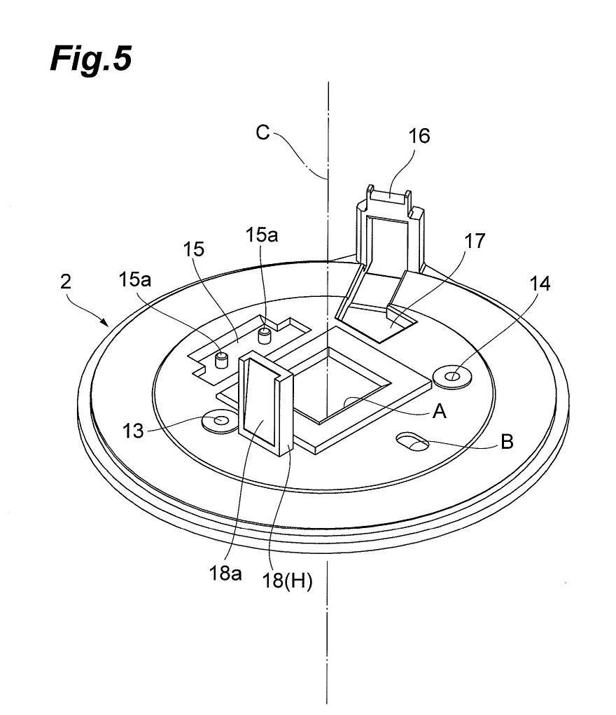

The first yoke 5 is a U-shaped member provided upright on the base member 2. The first yoke 5 has two sidewalls 5a and 5b extending along the optical axis direction C and a joint portion 5c joining the side walls 5a and 5b. The first yoke 5 is fitted in a yoke groove 15 of the base member 2 at the joint portion 5c and opens toward the direction opposite to the base member 2 (see FIG. 5). Two fixing pins 15a protrude from the bottom surface of the yoke groove 15. These fixing pins 15a are press-fitted in pin holes (not shown) formed in the joint portion 5c of the first yoke 5.

The magnet 6 is a plate-shaped magnet adhesively fixed to the inside of the first yoke 5. The magnet 6 is arranged along the inner surface of the side wall 5a at the opening A side, of the side walls 5a and 5b of the first yoke 5.

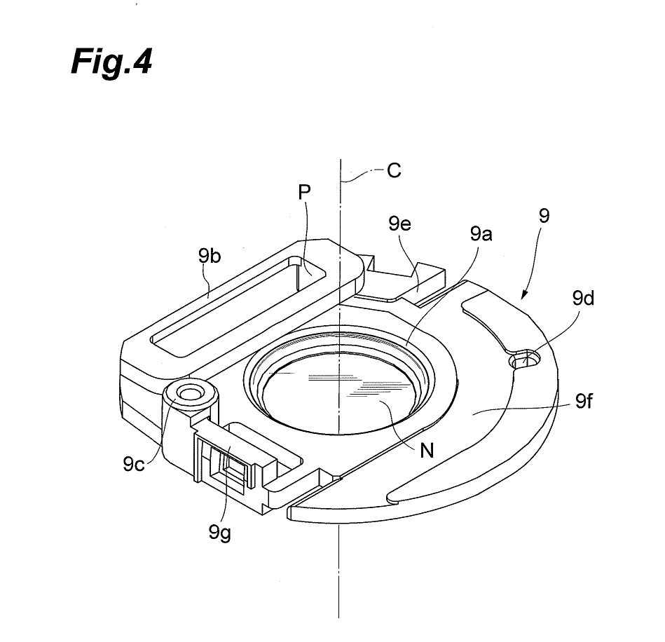

The coil 8 is an air-core coil integrally fixed to the lens frame 9 and drives the lens frame 9 in the optical axis direction C in cooperation with the magnet 6. A coil fixing portion 9b of the lens frame 9 is adhesively fixed to the coil 8 while covering the coil 8 (see FIG. 4). The side wall 5a of the first yoke 5 and the magnet 6 are inserted through the coil 8 and an air coil portion P of the coil fixing portion 9b. The coil 8 and the coil fixing portion 9b move along the side wall 5a of the first yoke 5 and the magnet 6 in the optical axis direction of the lens N.

The second yoke 7 is a plate-shaped member arranged to the tip ends of the first yoke 5. The second yoke 7 is arranged so as to join the side walls 5a and 5b at the tip end side of the first yoke 5. Projections and depressions are formed on the side surface of the plate-shaped second yoke 7 so as to mesh with the tip ends of the side walls 5a and 5b of the first yoke 5. The second yoke 7 and the first yoke 5 are fixed together with the projections and depressions in mesh.

A visual recognition hole B for visually recognizing the lens frame 9 is also formed in the base member 2. The visual recognition hole B is a through hole passing through the base member 2 in the optical axis direction C. The visual recognition hole B is formed opposite to the yoke groove 15 as viewed from the opening A. The position of the lens frame 9 in front of the base member 2 can be visually recognized from the back of the base member 2 through the visual recognition hole B. The provision of such a visual recognition hole B facilitates position adjustment of the lens frame 9 even after the lens drive device 1 is mounted inside the lens barrel T, thereby improving the operation efficiency.

As shown in FIG. 1 to FIG. 3, the FPC 10 is a circuit board for transmitting an electrical signal between the lens drive device 1 and another device. The FPC 10 is connected to the photoreflector 11. The FPC 10 has a connection portion 10a, a junction portion 10b, a folded portion 10c, and a terminal 10d.

The connection portion 10a is a section connected to the photoreflector 11 fixed to the lens frame 9. The connection portion 10a is provided outside a PR holding portion 9g of the lens frame 9 and is connected to the back surface of the photoreflector 11 in the lens frame 9. The junction portion 10b is a section connecting the connection portion 10a with the folded portion 10c. The connection portion 10a side of the junction portion 10b is arranged in an FPC groove 9f formed on the surface of the lens frame 9 (see FIG. 4). The folded portion 10c side of the junction portion 10b reaches the back side of the lens frame 9 through an FCP through hole 9e of the lens frame 9 and enters an FPC groove 17 on the base member 2.

The folded portion 10c is a section supported on an FCP support portion 16 of the base member 2. The folded portion 10c is hung on the plate-shaped FPC support portion 16 standing from the base member 2 in the optical axis direction C (see FIG. 5). The folded portion 10c is folded at the tip end of the FPC support portion 16 and reaches the back side of the base member 2. The terminal 10d is a section connected to another device on the back side of the base member 2. The FPC 10 is not fixed with respect to the base member 2 and moves along with the lens frame 9.

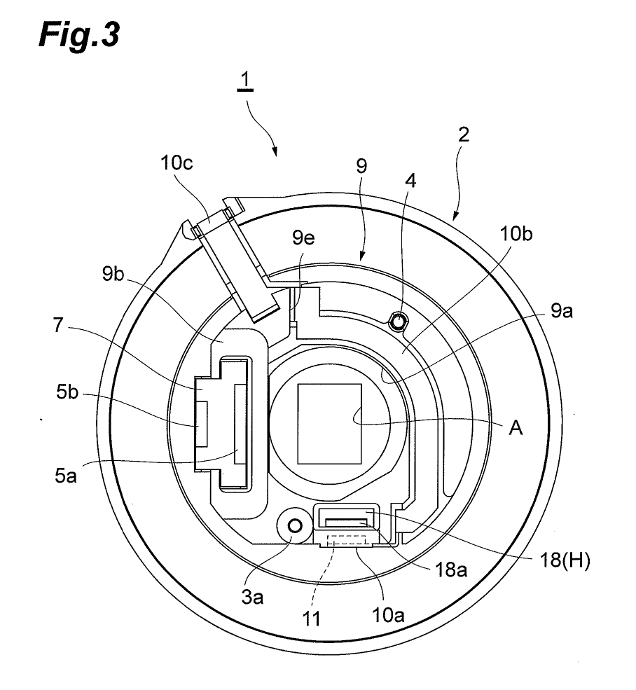

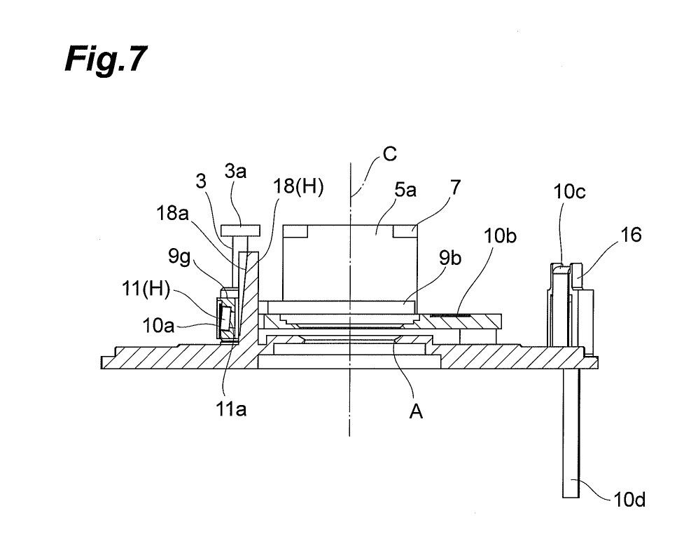

As shown in FIG. 1, FIG. 3, and FIG. 7, the photoreflector 11 is a detector shaped in a rectangular parallelepiped for detecting the position of the lens frame 9. The photoreflector 11 detects the position of the lens frame 9 in cooperation with a reflection portion 18 on the base member 2. The photoreflector 11 and the reflection portion 18 constitute a position detection unit H of the lens frame 9.

The reflection portion 18 is a thick plate-shaped upright piece provided upright on the base member 2 in the optical axis direction C. The reflection portion 18 has a reflection flat surface 18a for reflecting light from the photoreflector 11. The reflection flat surface 18a is provided inclined with respect to the optical axis C of the lens N. The reflection flat surface 18a is inclined in the direction closer to the optical axis C as the distance from the base member 2 increases. Such a reflection flat surface 18a is formed, for example, by metal coating such as aluminum deposition or by bonding a metal plate.

The photoreflector 11 has a light projecting portion applying light to the reflection flat surface 18a of the reflection portion 18 and a light receiving portion receiving light reflected on the reflection flat surface 18a (neither shown in the drawings). The photoreflector 11 is arranged such that a light projecting/receiving surface 11a faces the reflection flat surface 18a. That is, the photoreflector 11 is arranged such that the light projecting/receiving surface 11a is parallel to the reflection flat surface 18a.

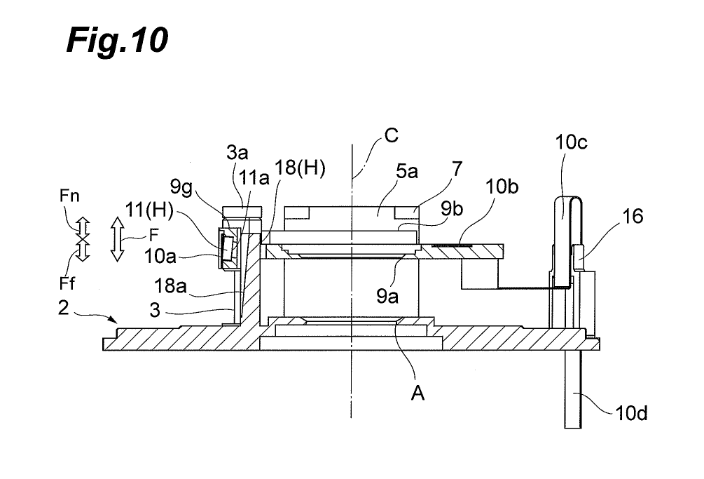

In the position detection unit H, the distance between the light projecting/receiving surface 1 la of the photoreflector 11 and the reflection flat surface 18a of the reflection portion 18 changes in accordance with the position of the lens frame 9. The photoreflector 11 detects the distance between the light projecting/receiving surface 11a and the reflection flat surface 18a thereby detecting the position of the lens frame 9 (see FIG. 7 and FIG. 10).

In the lens drive device 1 having such a configuration, the reflection flat surface 18a of the reflection portion 18 is inclined with respect to the optical axis C, so that the distance between the light projecting/receiving surface 11a of the photoreflector 11 and the reflection flat surface 18a continuously changes in accordance with the position of the lens frame 9. Since the reflection flat surface 18a is a flat surface having constant inclination, the position of the lens frame 9 can be specified based on the distance between the reflection flat surface 18a and the light projecting/receiving surface 11a. The lens drive device 1 therefore can detect the distance from the reflection flat surface 18a using the photoreflector 11 thereby precisely specifying the position of the lens frame 9 corresponding to the detected distance. Accordingly, lens position detection can be performed with high accuracy and high resolution.

In this lens drive device 1 compared with a case where the photoreflector 11 directly detects the moving distance of the lens frame 9, the device can be reduced in size in the optical axis direction C because the photoreflector 11 and the reflection flat surface 18a do not have to be opposed to each other in the optical axis direction C.

Furthermore, in this lens drive device 1 compared with the case where the photoreflector 11 directly detects the moving distance of the lens frame 9, the distance detection range required of the photoreflector 11 can be reduced. This is advantageous in terms of size reduction and cost reduction of the photoreflector 11.

This lens drive device 1 employs a configuration in which the light projecting/receiving surface 11a and the reflection flat surface 18a face each other, so that light can be reliably projected/received by the photoreflector compared with a case where the light projecting/receiving surface 11a and the reflection flat surface 18a do not face each other. The detection accuracy of the photoreflector is thus improved.

In this lens drive device 1 compared with a case where the reflection portion 18 is provided to the lens frame 9, it is not necessary to arrange the photoreflector 11 at a distance from the base member 2 in order to accommodate the moving range of the lens frame 9. This can simplify the structure and is advantageous in size reduction of the device. Since it is not necessary to support the photoreflector 11 at a distance, the detection accuracy of the photoreflector is ensured while improvement in durability of the device is achieved.

Control of the lens position detection in the lens drive device 1 will now be described.

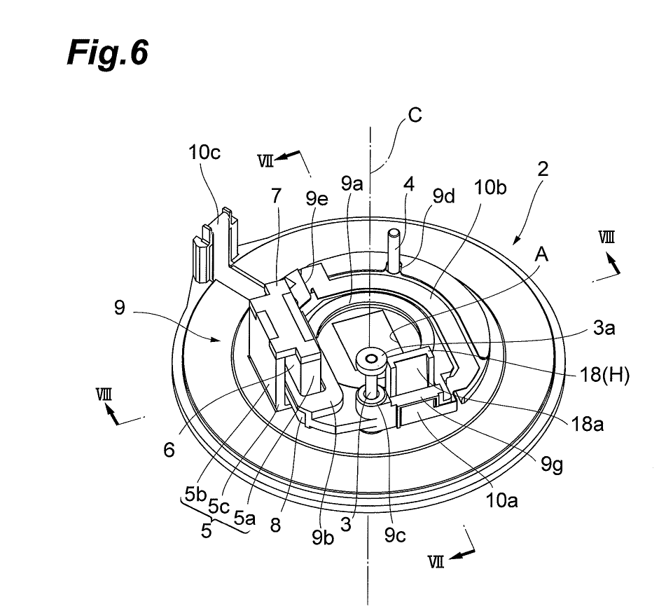

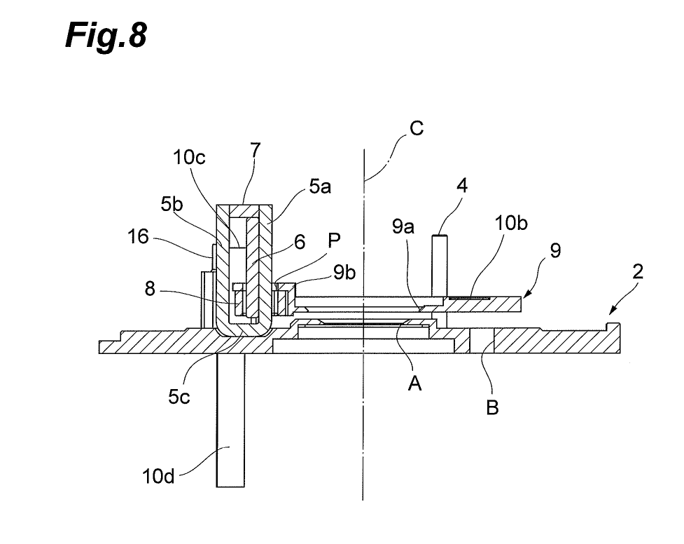

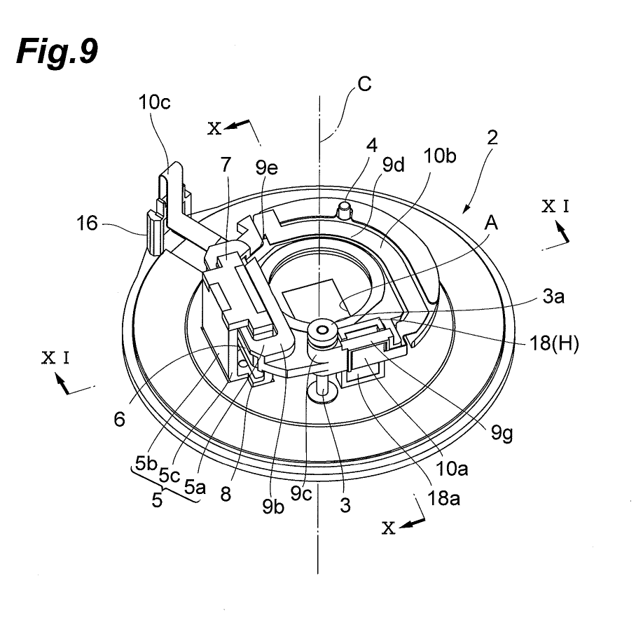

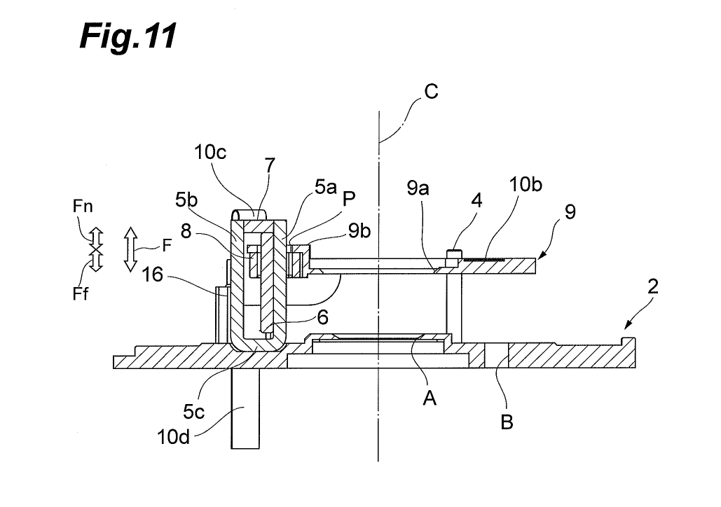

FIG. 6 to FIG. 8 are diagrams showing a state in which the lens frame 9 is at a camera stop position. The camera stop position is a position of the lens frame 9 when the power of the camera is OFF, and is an initial position of the lens frame 9. When the lens frame 9 is located at the camera stop position, the lens barrel T is in a retracted state in which it is stored in the camera body. FIG. 9 to FIG. 11 are diagrams showing a state in which the lens frame 9 is at a stopper position. The stopper position refers to a position where the lens frame 9 abuts on the stopper 3a of the guide shaft 3 and is a limit position of the moving range of the lens frame 9.

As shown in FIG. 6 to FIG. 11, in the lens drive device 1, when the camera is powered ON, the voice coil motor V is driven to drive the lens frame 9 from the camera stop position to a focus area F. The focus area F refers to a lens position detection area used to focus on a target to be imaged. The lens drive device 1 adjusts the position of the lens N within the focus area F so as to focus on the target to be imaged by the camera.

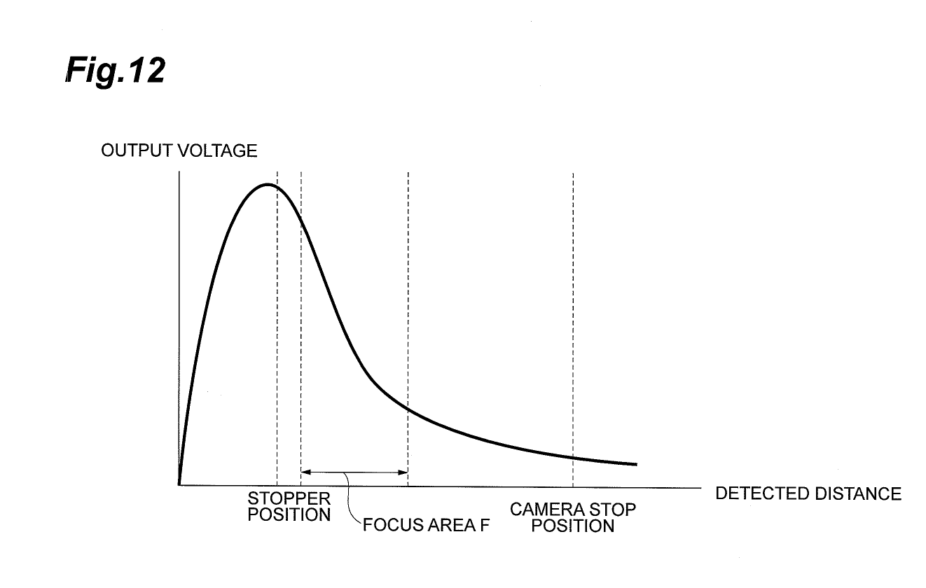

Here, FIG. 12 is a graph for explaining the focus area F in an output voltage characteristic of the photoreflector 11. The output voltage characteristic of the photoreflector 11 means the relationship between the detected distance and the output voltage of the photoreflector 11. The detected distance refers to the distance, which is detected by the photoreflector 11, between the light projecting/receiving surface 11a and the reflection flat surface 18a. In FIG. 12, the ordinate indicates the output voltage, and the abscissa indicates the detected distance.

As shown in FIG. 12, the output voltage characteristic of the photoreflector 11 is represented as a curve that rises from the zero distance up to a predetermined peak as the detected distance increases and that gradually drops in accordance with the length of the detected distance after reaching the maximum at the peak distance. In such an output voltage characteristic, the greater is the rate of change of the output voltage with respect to the detected distance, the finer position detection is achieved by measuring the output voltage. Based on this, a range in which the rate of change is high is set as the focus area F. In addition, a range in which there are small variations in the rate of change, that is, linearity is high is selected as the focus area F. For lens position detection during camera stop, that is, when a return to the initial position of the lens frame 9 is detected, in which case fine position detection is not required, a range in which the rate of change is low is set as the lens position detection area for camera stop.

In this lens drive device 1, a range in which the rate of change of the output voltage with respect to the detected distance is high is set as the focus area, while a range in which the rate of change is smaller than in the focus area F is set as the lens position detection area for camera stop. Accordingly, in this lens drive device 1 compared with a conventional device that uses only a range in which the rate of change is high and linearity is high for the lens position detection, a wide output voltage characteristic can be used, so that a detectable range of the lens position can be enlarged. The use of a wide output voltage characteristic as the focus area F can improve the accuracy of lens position detection.

The focus area F can be divided into a fine movement area Fn and a coarse movement area Ff. The fine movement area Fn refers to the position range of the lens N to be used to focus on a subject at a short distance, in which fine lens position detection is required. The coarse movement area Ff refers to the position range of the lens N to be used to focus on a subject at a long distance, in which adjustment can be made with lens position detection coarser than the fine movement area Fn. The fine movement area Fn corresponds to a lens position detection area for short distance, and the coarse movement area Ff corresponds to a lens position detection area for long distance.

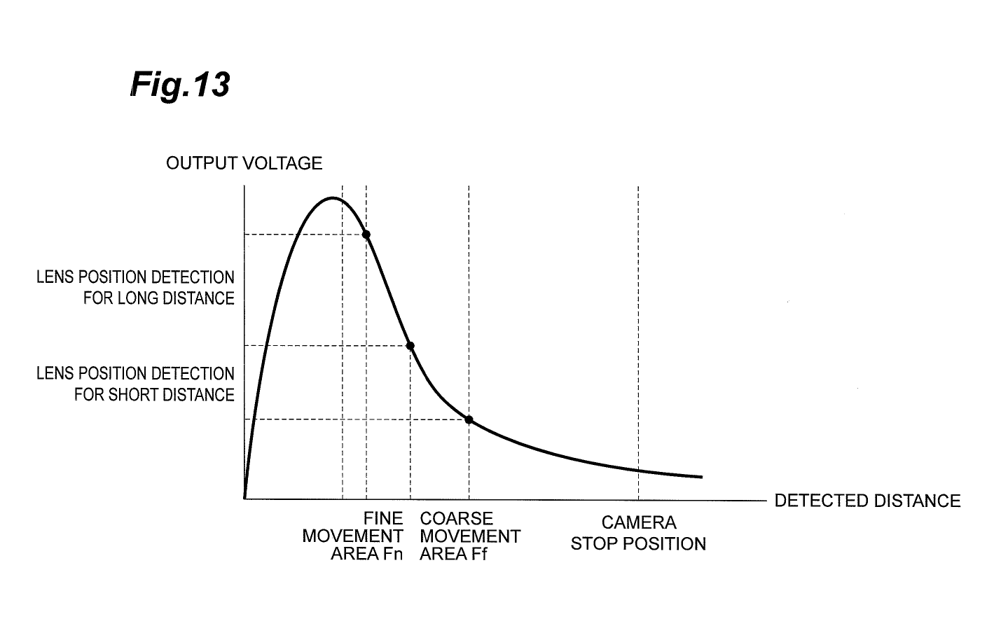

FIG. 13 is a graph for explaining the fine movement area Fn and the coarse movement area Ff in the output voltage characteristic of the photoreflector 11. In FIG. 13, the focus area F in FIG. 12 is divided into the fine movement area Fn and the coarse movement area Ff.

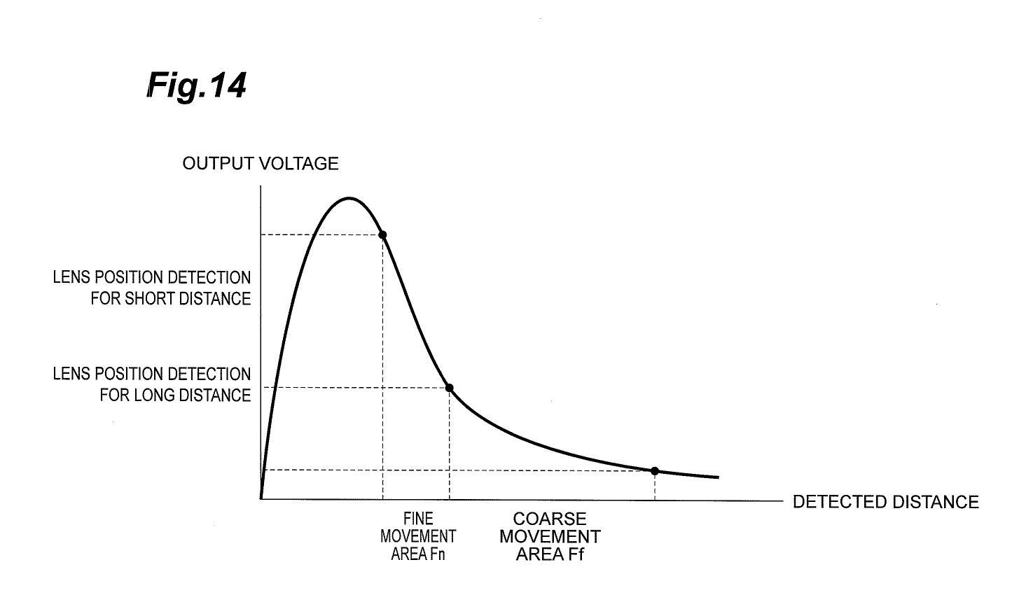

The focus area F, the fine movement area Fn, and the coarse movement area Ff are not limited to the ranges shown in FIG. 12 and FIG. 13. FIG. 14 is a graph showing an example in which wider ranges than in FIG. 13 are set as the fine movement area Fn and the coarse movement area Ff. In FIG. 14, in the range of the output voltage characteristic of the photoreflector 11 after the output voltage exceeds the peak, a range in which the rate of change of the output voltage with respect to the detected distance is high is set as the fine movement area Fn, and a range in which the rate of change is smaller than in the fine movement area Fn is set as the coarse movement area Ff.

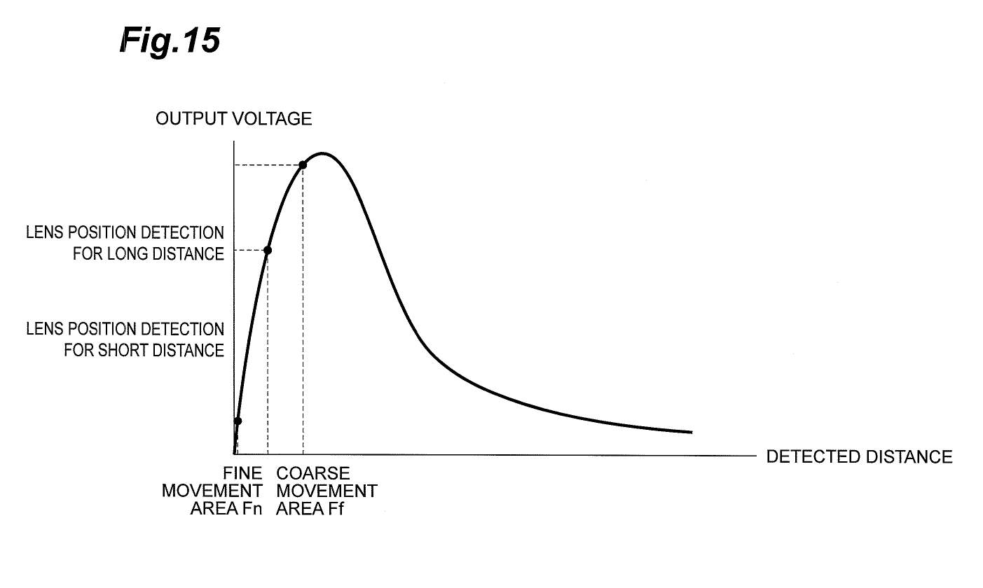

FIG. 15 is a graph showing an example in which a range of the output voltage characteristic of the photoreflector 11 before the output voltage exceeds the peak is set as the fine movement area Fn and the coarse movement area Ff. In FIG. 15, in the range before the output voltage exceeds the peak, a range in which the rate of change of the output voltage with respect to the detected distance is high and linearity is high is set as the fine movement area Fn, and a range in which the rate of change is smaller than in the fine movement area Fn is set as the coarse movement area Ff.

In this lens drive device 1, the fine movement area Fn for short distance and the coarse movement area Ff for long distance are set in accordance with the magnitude of the rate of change of the output voltage with respect to the detected distance in the output voltage characteristic of the photoreflector 11, thereby implementing lens position detection suited for respective imaging conditions for short distance and for long distance.

Moreover, this lens drive device 1 uses the coarse movement area Ff for the lens position detection for long range and uses the fine movement area Fn for the lens position detection for short distance, thereby implementing accurate and fine position detection of the lens N during imaging at a short distance while ensuring the position detection accuracy of lens N that is necessary and sufficient for imaging at a long distance. Accordingly, in this lens drive device 1 compared with a case where a range in which the rate of change of the output voltage with respect to the detected distance is high and linearity is high is used both for the fine movement area Fn and for the coarse movement area Ff, the available range of the output voltage characteristic for the fine movement area Fn can be enlarged, thereby enabling accurate lens position detection during imaging at a short distance. This contributes to improvement of imaging performance of the camera for imaging at a short distance.

### Second Embodiment

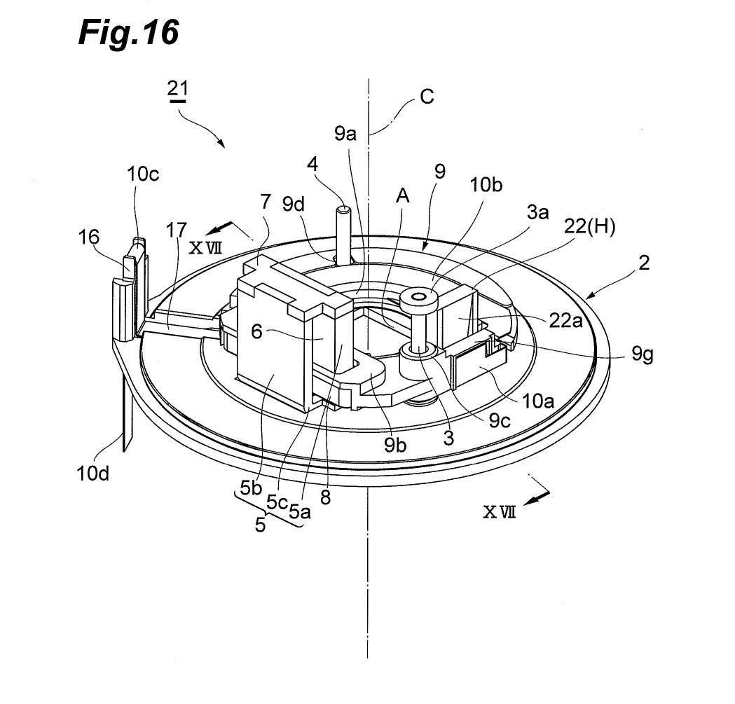

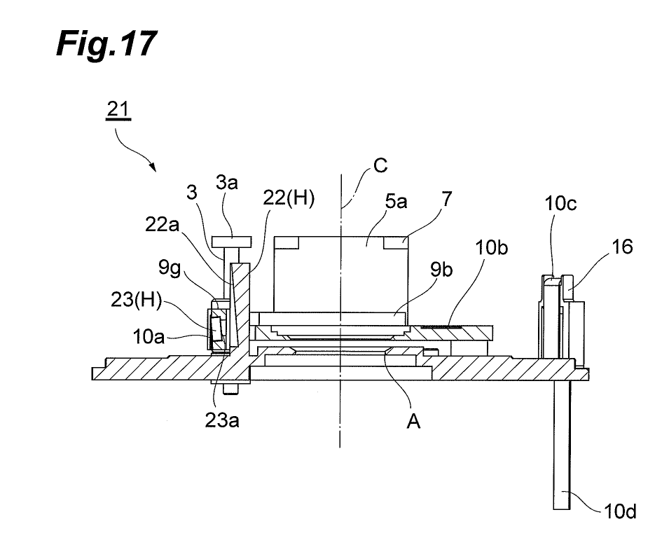

As shown in FIG. 16 and FIG. 17, a lens drive device 21 according to a second embodiment differs from the lens drive device 1 according to the first embodiment in the inclination direction of a reflection flat surface 22a of a reflection portion 22 and a light projecting/receiving surface 23a of a photoreflector 23.

Specifically, the reflection flat surface 22a of the reflection portion 22 according to the second embodiment is inclined in a direction further away from the optical axis C as the distance from the base member 2 increases. The photoreflector 23 is arranged such that the light projecting/receiving surface 23a faces the reflection flat surface 22a. That is, the light projecting/receiving surface 23a of the photoreflector 23 is arranged parallel to the reflection flat surface 22a and is inclined further away from the optical axis C as the distance from the base member 2 increases.

The lens drive device 21 having such a configuration achieves the similar effects as in the lens drive device 1 according to the first embodiment.

### Third Embodiment

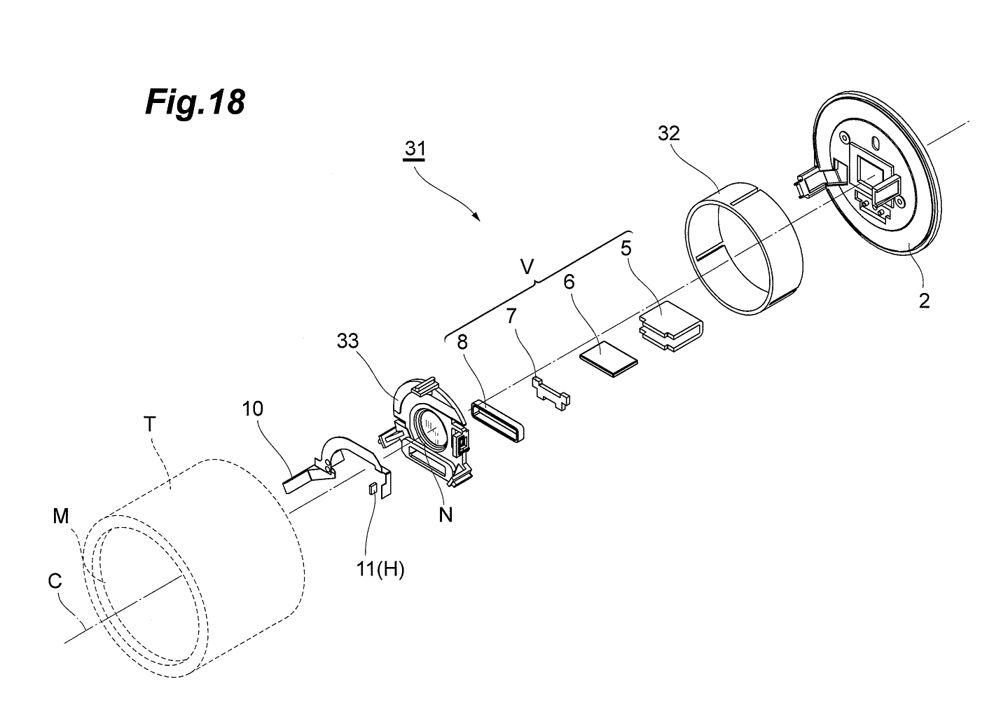

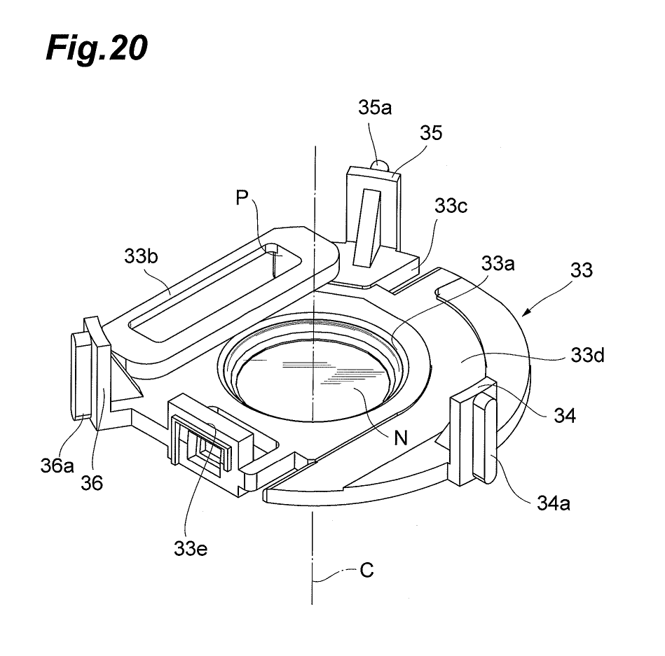

As shown in FIG. 18 to FIG. 20, a lens drive device 31 according to a third embodiment differs from the lens drive device 1 according to the first embodiment mainly in that it includes a cylindrical guide member 32 instead of the guide shafts 3 and 4 and in the shape of a lens frame 33.

The lens drive device 31 according to the third embodiment includes the cylindrical guide member 32 for guiding the movement of the lens frame 33 in the optical axis direction C. The guide member 32 is arranged so as to surround the lens frame 33 on the base member 2. The guide member 32 has three guide grooves 32a, 32b, and 32c extending along the optical axis direction C. The guide grooves 32a, 32b, and 32c are formed at regular intervals in the circumferential direction of the guide member 32. These guide grooves 32a, 32b, and 32c open toward the base member 2 and are closed on the opposite side.

The lens frame 33 differs from the lens frame 9 according to the first embodiment in that it does not have the shaft insertion holes 9c and 9d and in that it has three standing pieces 34, 35, and 36. A lens hole 33a, a coil fixing portion 33b, an FPC through hole 33c, an FPC groove 33d, and a PR holding portion 33e have the same configuration as those in the lens frame 9, and a description thereof is therefore omitted.

The standing pieces 34, 35, and 36 are members standing from the outer periphery of the lens frame 33 in the optical axis direction C. The standing pieces 34, 35, and 36 are provided at positions corresponding to the guide grooves 32a, 32b, and 32c, respectively, of the guide member 32. Projection portions 34a, 35a, and 36a that enter the guide grooves 32a, 32b, and 32c, respectively, are formed on the respective outer side surfaces of the standing pieces 34, 35, and 36.

In this lens drive device 31, the projection portions 34a, 35a, and 36a engaged with the guide grooves 32a, 32b, and 32c of the guide member 32 slide in the guide grooves 32a, 32b, and 32c in accordance with the movement of the lens frame 33 thereby allowing the lens frame 33 to be moved accurately in the optical axis direction C. The guide grooves 32a, 32b, and 32c also function as stoppers for restricting the moving range of the lens frame 33 because the projection portions 34a, 35a, and 36a reach the respective end portions of the guide grooves 32a, 32b, and 32c thereby restricting the movement of the lens frame 33.

The present invention is not limited to the foregoing embodiments.

For example, the imaging device according to the present invention includes, in addition to a digital camera and a film camera, a portable information terminal such as a mobile phone with an imaging function, a portable personal computer, and a PDA.

The photoreflector 11 and the reflection portion 18 may be in an inversed positional relationship. Specifically, the photoreflector 11 may be provided to the base member 2, and the reflection portion 18 may be provided to the lens frame 9. The light projecting/receiving surface 11a of the photoreflector 11 and the reflection flat surface 18a of the reflection portion 18 are not necessarily arranged parallel to each other. The driving means for the lens frame 9 is not limited to a voice coil motor. A magnet movable motor or a piezo-motor may be used.

In the output voltage characteristic of the photoreflector 11, the focus area F for camera focus and the lens position detection area for camera stop may be switched. Specifically, a range in which the rate of change of the output voltage with respect to the detected distance is high may be set as the lens position detection area for camera stop while a range in which the rate of change is small may be set as the focus area F. Similarly, in the output voltage characteristic of the photoreflector 11, the fine movement area Fn in which the rate of change of the output voltage with respect to the detected distance is high may be set as the lens detection area for long distance while the coarse movement area Ff in which the rate of change is small may be set as the lens detection area for short range.

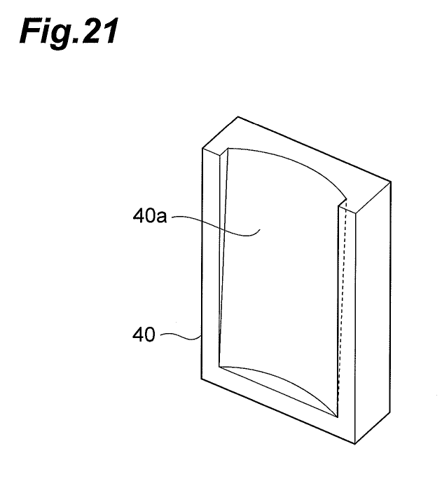

As shown in FIG. 21, the reflection surface is formed as a reflection curved surface 40a inclined with respect to the optical axis C of the lens N. This reflection curved surface 40a is a concave mirror capable of collecting light. The reflection surface formed with the curved surface 40a capable of collecting light enables sensing light efficiently with a small quantity of light and improving the accuracy of position detection even with a small reflection portion 40.

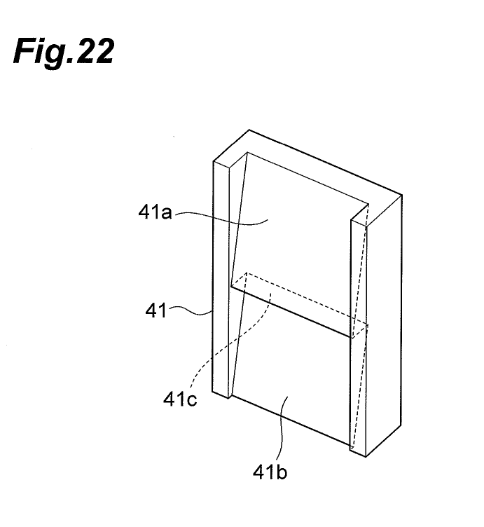

As shown in FIG. 22, the reflection surface is formed in a sawtooth shape in a cross section. The reflection surface has two reflection surfaces 41a and 41b having the same inclination angle. The inclination angle of each of the reflection surfaces 41a and 41b having a planar shape is greater than that of the reflection flat surface 18a described above, and a step portion 41c that is not inclined is arranged between the reflection surface 41a and the reflection surface 41b. By employing such a configuration, the inclination angle of the reflection surfaces 41a and 41b can be increased. This can increase a change in the amount of receiving light and can improve the accuracy of position detection even if the reflection portion 41 is small. The reflection surfaces 41a and 41b may be formed as curved surfaces, and a plurality of step portions 41c may be arranged in parallel in the optical axis C direction.

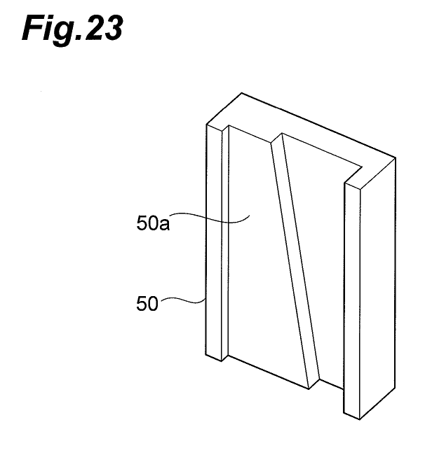

As shown in FIG. 23, the area of a reflection surface 50a of a reflection portion 50 as a related technique may be varied so as to continuously increase or decrease in the optical axis direction. In this manner, the reflection area of the reflection surface 50a is varied to change the amount of receiving light, thereby enabling position detection.

The reflection surfaces 18a, 22a, 40a, 41a, 41b, and 50a as described above can be applied to either of folded optics with an optical path bent by a prism and retractable optics with a barrel shrunken and stored in the main body. The lens drive devices 1, 21, and 31 have the retractable optics.

An IR cut filter (not shown) may be arranged to be opposed to an imaging element (not shown) so as to close the opening A on the optical axis C. By employing the IR cut filter, the imaging element does not receive infrared rays emitted from the light projecting portion of the photoreflector 11. Thus, it is possible to prevent influence of the infrared rays on imaging. Accordingly, the photoreflector 11 is easily arranged in the vicinity of the imaging element, which contributes to size reduction of the lens drive devices 1, 21, and 31.

### REFERENCE SIGNS LIST

1, 21, 31 lens drive device
2 base member
3, 4 guide shaft
3a stopper
5 first yoke
6 magnet
7 second yoke
8 coil
9, 33 lens frame
9a, 33a lens hole
10 FPC
11, 23 photoreflector
11a, 23a light projecting/receiving surface
18, 22, 40, 41 reflection portion
18a, 22a, 41a, 41b reflection flat surface (reflection surface)
40a reflection curved surface (reflection surface)
32 guide member
32a, 32b, 32c guide groove
34, 35, 36 standing piece
34a, 35a, 36a projection portion
B visual recognition hole
C optical axis
F focus area
Ff coarse movement area
Fn fine movement area
H position detection unit (position detection means)
M master lens
N focus lens
T lens barrel
V voice coil motor (driving means).

1-11. (canceled)

12. A lens drive device comprising:
a base arranged inside a barrel;
a lens frame holding a lens and provided to be movable with respect to the base in an optical axis direction of the lens;
driving unit configured to move the lens frame; and
position detection unit configured to detect a position of the lens frame, wherein
the position detection unit includes
a reflection portion provided to one of the base and the lens frame and including a reflection surface inclined with respect to the optical axis of the lens, and
a photoreflector provided to the other of the base and the lens frame and including a light projecting portion applying light to the reflection surface and a light receiving portion receiving light reflected on the reflection surface.

13. The lens drive device according to claim 12, wherein
the reflection surface of the reflection portion and a light projecting/receiving surface of the photoreflector face each other.

14. The lens drive device according to claim 12, wherein
the base is a plate-shaped member,
the reflection portion is an upright piece provided upright on the base along the optical axis direction, and
the photoreflector is provided to the lens frame.

15. The lens drive device according to claim 12, wherein, in an output voltage characteristic of the photoreflector with respect to a distance between the photoreflector and the reflection surface, a range in which a rate of change of the output voltage with respect to the distance is high is set as a lens position detection area for either a lens position detection area for focus or a lens position detection area for camera stop, and another range in which the rate of change is smaller than in the range is set as the other lens position detection area.

16. The lens drive device according to claim 12, wherein, in a lens position detection area for focus in the output voltage characteristic of the photoreflector with respect to a distance between the photoreflector and the reflection surface, a range in which a rate of change of the output voltage with respect to the distance is high is set as a lens position detection area for either a lens position detection area for short distance or a lens position detection area for long distance, and another range in which the rate of change is smaller than in the range is set as the other lens position detection area.

17. The lens drive device according to claim 12, further comprising a guide shaft that is fixed to the base, extends in the optical axis direction, and includes a stopper for restricting a moving range of the lens frame provided to a free end of the guide shaft.

18. The lens drive device according to claim 12, further comprising a tubular guide member that has a guide groove extending in the optical axis direction and is fixed to the base while surrounding the lens frame, wherein
the lens frame includes a projection portion that is engaged with the guide groove and is slidable along the guide groove.

19. The lens drive device according to claim 12, wherein the base has a visual recognition hole for visually recognizing the lens frame.

20. The lens drive device according to claim 12, wherein the reflection surface is a flat surface or a curved surface capable of collecting light.

21. The lens drive device according to claim 20, wherein the reflection surface is formed in a sawtooth shape in a cross section.

22. An imaging device comprising the lens drive device according to claim 12.

23. A lens drive device comprising:
a base arranged inside a barrel;
a lens frame holding a lens and provided to be movable with respect to the base in an optical axis direction of the lens;
driving means for moving the lens frame; and
position detection means for detecting a position of the lens frame, wherein
the position detection means includes
a reflection portion provided to one of the base and the lens frame and including a reflection surface inclined with respect to the optical axis of the lens, and
a photoreflector provided to the other of the base and the lens frame and including a light projecting portion applying light to the reflection surface and a light receiving portion receiving light reflected on the reflection surface.
